(19) United States
(12) Patent Application Publication
(10) Pub. No.: US 2019/0078041 A1
(43) Pub. Date: Mar. 14, 2019

(54) BAR SOAP ANCHORING CORE METHOD OF USE

(71) Applicant: Nabil Radi Abdou, Carson, CA (US)

(72) Inventor: Nabil Radi Abdou, Carson, CA (US)

(21) Appl. No.: 16/158,184

(22) Filed: Oct. 11, 2018

Related U.S. Application Data
(62) Division of application No. 14/720,192, filed on May 22, 2015.

(51) Int. Cl. C11D 17/04

(52) U.S. Cl. CPC C11D 17/048; C11D 17/04

(57) ABSTRACT

A method of using a soap anchor to preserve the structural integrity of used bar soap includes affixing pieces of the used bar soap into depressions found in the top and/or bottom of the soap anchor. After using the pieces of bar soap, the soap anchor may be reused by affixing additional pieces of bar soap. Another method may be pressing solid soap pieces into anchoring structures on the top and bottom faces of a planar core, and pressing additional solid soap pieces into the anchoring structures as needed.

This application is a divisional of application Ser. No. 14/720,192 filed May 22, 2015 entitled “Bar Soap Anchoring Core” to which the present application claims priority.

### BACKGROUND

### 1. Field of the Invention

The present invention generally relates to bar soap. More specifically, the present invention relates to bar soap having an anchoring core inside.

### 2. State of the Art

Soaps, including conventional soaps for personal use are made in both liquid and solid phases. While some solid soaps are dried or powdered, the conventional solid ingot or bar shape remains the most popular way of presenting soap for sale or use. While bar soaps are popular, as they wear down through use, they tend to lose integrity and will bend or break through normal use. When bar soaps break up, the resulting pieces are usually lost down basin drains, or discarded, resulting in a waste of soap.

In addition to home use, bar soaps are popular in commercial settings, such as hotels. In these settings, a small bar soap is usually presented to avoid the expense of wasting large amounts of soap, since users only need the soap for a few days at most, and a new soap must be used for each new guest. Guests also usually take soaps with them when they leave a hotel. Since hotel soaps begin small, the risk of disintegration is greater. Also, hotels miss a branding opportunity, since any promotional logos that may be printed on a bar soap is washed away after only a few uses.

Hence, what is needed is an apparatus that provides structural integrity to bar soaps as they become smaller and thinner through use. Also needed is an apparatus that retains soap pieces, allowing users to completely use up the soap before replacement. Another need is an apparatus that retains bar soaps, prevents them from breaking up, and that also can be branded, reused and recycled. These and other needs are addressed in the following summary, description and claims.

### SUMMARY

An anchoring core for preserving the structural integrity of bar soap is disclosed. The anchoring core includes a substantially planar top face and a substantially planar bottom face opposing the top face. The top face and the bottom face are preferably in peripheral contour with each other, and a perimeter wall extends around the periphery of the anchoring core defining a profile contour. To provide smoothness, a curved area transitions the perimeter wall into the top face and into the bottom face.

The top face includes a depression sunk inward of the top face. Unlike the perimeter of the anchoring core, the transition from the top face to the depression creates an angle of at least ninety degrees to form a lip where the depression meets the top face. Portions of the bar soap are urged into the depression and consequently held in the depression, which prevents the bar soap from moving relative to the anchoring core.

In preferred embodiments, the anchoring core includes a depression formed in both the top face and the bottom face, and preferably will have multiple individual depressions formed in the top face and bottom face of the anchoring core. If desired, the multiple depressions may be formed into a predetermined pattern. Alternatively, a single depression may be formed in a predetermined pattern. Contemplated patterns may be images, words or any preferred indicia. The depression, depressions and any pattern may be formed in the top face and in the bottom face such that the top face and bottom face are substantially identical mirror images of each other.

In some embodiments, the depression may be formed as an elongated channel. The elongated channel can extend across the top face, across the bottom face, and can extend continuously across the perimeter wall such that it wraps around the anchoring core. If the depression is a channel, the channel may be curved, or formed into fanciful shapes and indicia. Additionally, the anchoring core may include multiple channels. Preferably, the anchoring core is centered in the soap bar.

The invention can also be characterized as a strengthened bar of soap, which is resilient and break resistant. The soap bar, as is conventional, would have a perimeter profile. In this context, the soap bar itself includes an anchoring core having a top face, a bottom face opposing the top face, with the bottom face in peripheral contour with the top face. A perimeter wall defining a common perimeter of the top face and the bottom face includes a curved area transitioning the perimeter wall to the top face and transitioning the perimeter to the bottom face, and the top face and the bottom face, as discussed, include depressions disposed inward of the top face and inward of the bottom face, the depressions transitioning from the top face at least at a ninety degree angle.

Ideally, the perimeter wall of the anchoring core is disposed inward of the perimeter of the bar soap, and has the same contour in profile, so the bar soap has the anchoring member centered within it. The depression can be a simple dot-shaped depression or may be an elongated channel. In certain instances, the elongated channel may extend across the perimeter wall from the top face to the bottom face.

A preferred method of using a soap anchor core to preserve the structural integrity of used bar soap includes affixing pieces of the used bar soap into depressions found in the top and/or bottom of the soap anchor. After using the bar soap, e.g. for showering, the soap anchor may be reused by affixing additional pieces of bar soap as desired. A preferred method may also be described as pressing solid soap pieces into anchoring structures on the top and bottom faces of a planar core, and using the same for washing purposes, and pressing additional solid soap pieces into the anchoring structures as needed.

### BRIEF DESCRIPTION OF THE FIGURES

FIG. 1 illustrates a top view of a first embodiment bar soap anchoring core, the bottom view being a mirror image thereof;

FIG. 2 illustrates a right side view of the first embodiment bar soap anchoring core, the left side view being a mirror image thereof;

FIG. 3 illustrates a sectional view of the first embodiment bar soap anchoring core;

FIG. 4 Illustrates a top view of a second embodiment bar soap anchoring core, the bottom view being a mirror image thereof;

FIG. 5 Illustrates a right side view of the second embodiment bar soap anchoring core;

FIG. 6 illustrates a top view of the second embodiment bar soap anchoring core embedded in a bar of soap;

FIG. 7 illustrates a section view of the second embodiment bar soap anchoring core embedded in a bar of soap;

FIG. 8 illustrates a top view of a third embodiment bar soap anchoring core embedded in a bar of soap.

### DETAILED DESCRIPTION

The following description is presented to enable any person skilled in the art to make and use the invention, and is provided n the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

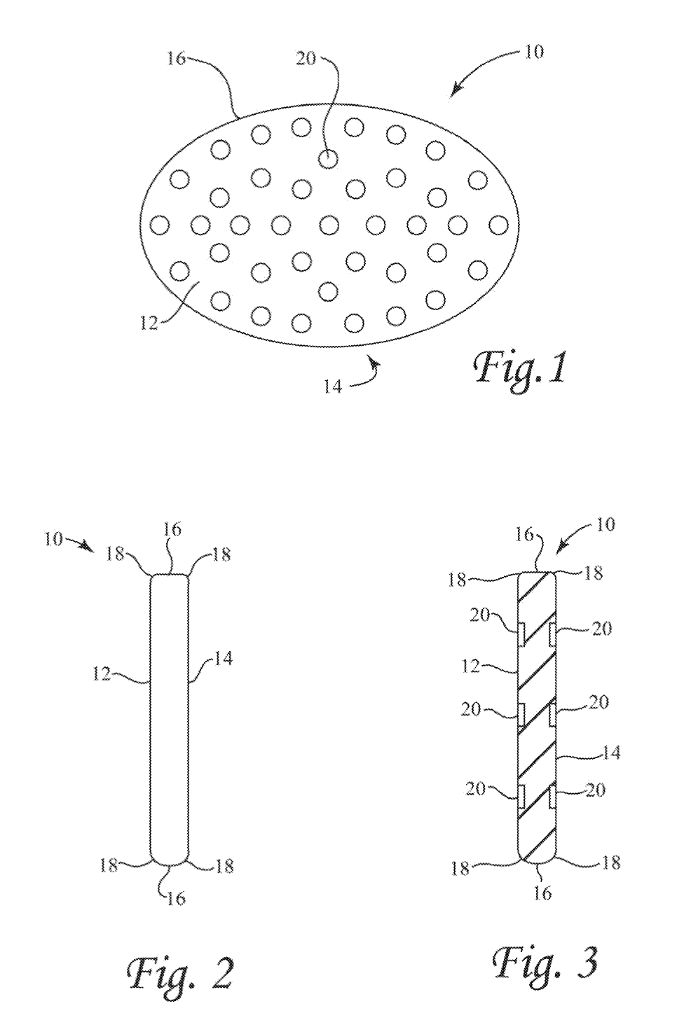

Referring to FIGS. 1 and 2, a first embodiment of the bar soap anchoring core (“anchoring core”) 10 is shown in top view and side view. The anchoring core 10 is a substantially planar piece, preferably of a uniform thickness, having a top face 12, a bottom face 14 (not shown in FIG. 1), and a perimeter wall 16. Since a common design of bar soap 112 (not shown) is an oval or ovoid shape, the perimeter wall 16 preferably substantially compliments the oval perimeter of the bar soap 112, allowing the anchoring core 10 to be centered inside the bar soap 112. Although an oval perimeter wall 16 is shown in the exemplary embodiment, other shapes corresponding to other common soap shapes are contemplated, e.g., square, round, etc.

In order to anchor bar soap 112 on the anchoring member 10 a series of depressions 20 are formed in the top face 12 and in the bottom face 14. In the illustrated embodiment, approximately forty depressions 20 are in the same pattern on the top face 12 and on the bottom face 14. In alternative embodiments, the depressions 20 may have a different arrangement, including being differently spaced (e.g., into clusters forming shapes, etc.), being in different patterns on the top face 12 and bottom face 14, and in some embodiments being omitted from either the top face 12 or the bottom face 14 entirely.

In order to avoid presenting an overly rough surface which may potentially catch on a user's fingernail or otherwise cause a snag, the depressions are preferably relatively small in diameter. In a preferred embodiment, the depressions 20 are between 0.05 and 0.1 inches in diameter, including 0.85 inches. To effectively affix bar soap 112 to the anchoring core 10, the depressions 20 are ideally shallow enough to allow soap in the depressions 20 to be washed out as the last of the bar soap 112 is used, yet deep enough to provide an effective anchor. In preferred embodiments, the depressions 20 are between 0.01 and 0.02 inches deep, including 0.15 inches.

In order to prevent discomfort or injury when the anchoring core 10 begins emerging from the bar soap 112 as it is worn away through use, a curved area 18 connects the perimeter wall 16 to the top face 12 and to the bottom face 14. The curved area prevents the anchoring core 10 from scraping against a user's skin (not shown). In one preferred embodiment, the curved area has a radius of approximately 0.05 inches, including 0.047 inches. In some embodiments, the curved area 18 or areas 18 may comprise the entire perimeter wall 16.

Referring to FIG. 3, the anchoring core 10 is shown in section view. For aesthetic reasons, the depressions 20 are aligned on the top face 12 and on the bottom face 14 so that the same pattern will be displayed regardless of how the anchoring core 10 is displayed. In this view, the depth of the depressions 20 is also shown, which is approximately equal to the radius of the curved area 18 between the top face 12 and perimeter wall 16, and the bottom face 14 and the perimeter wall 16. Unlike the area adjacent the perimeter wall 16, the depressions 20 transition at approximately at least a ninety degree angle, so that soap catches on the depressions 20, affixing it to the anchoring core 10.

In preferred embodiments, the anchoring core 10 will be formed of resilient plastic to prevent flexing and disengaging from the bar soap 112. While maintaining rigidity, it is preferable to use as little material as possible, to keep manufacturing and delivery costs low, and avoid unduly increasing soap size. In developing the anchoring core 10, although a thickness of at least 0.25 inches was presumed optimal, a thickness of between 0.1 and 0.2 inches, including 0.15 inches yielded the unexpected result of effectively preventing the anchoring core from flexing, even when the bar soap 112 is substantially worn away or missing from the top face 12 or bottom face 14.

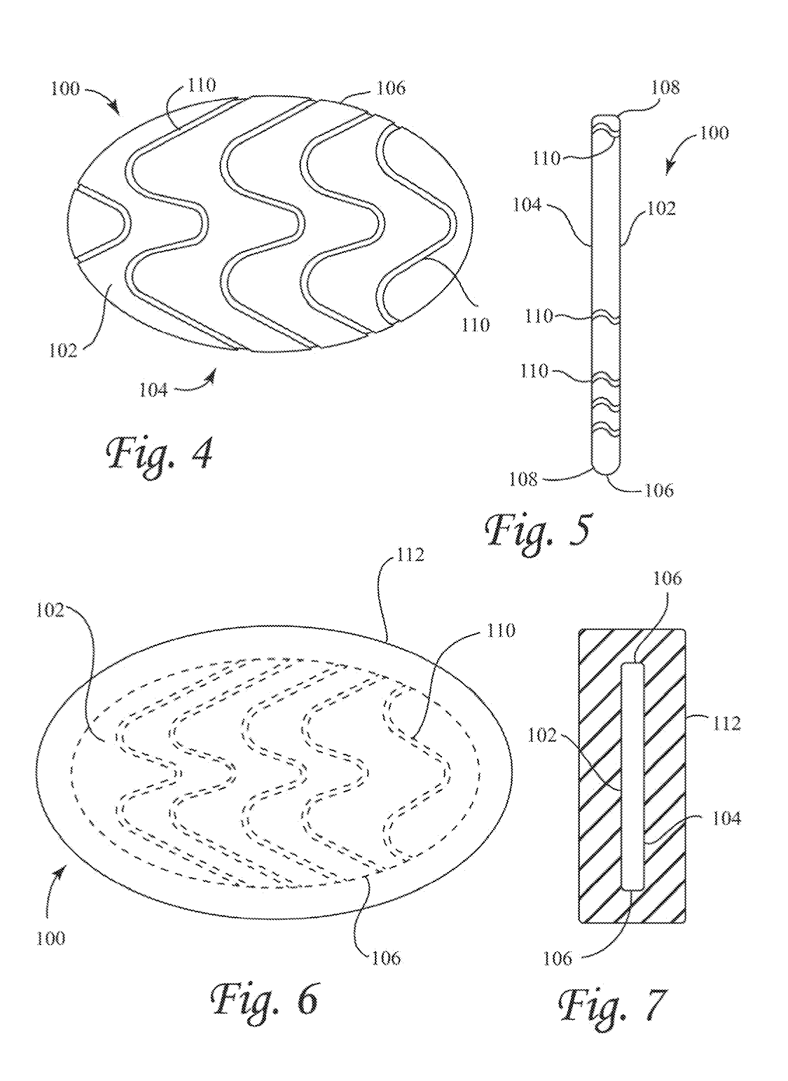

Referring to FIGS. 4 and 5, a second embodiment bar soap anchoring core (“anchoring core”) 100 is shown. This anchoring core 100 is also oval to correspond to an oval-shaped bar soap 112 (not shown), and includes a top face 102, a bottom face 104 and a perimeter wall. Like the first embodiment, the second embodiment anchoring core 100 also includes a curved area 108 between the top face 102 and the perimeter wall 106 and the bottom face 104 and the perimeter wall 106 to avoid scratching.

In order to the anchor bar soap 112 on the anchoring member 100 a series of grooves 110 are formed in the top face 102, in the bottom face 104, and on the perimeter wall 106. In the illustrated embodiment, the grooves 110 are contiguous, traveling in an uninterrupted pattern around the anchoring member 100. In the illustrated embodiment, the grooves 110 are shown in fanciful curved shapes to increase their aesthetic appearance. Due to the amorphous nature of the grooves' 110 shape, the pattern on the top face 102 is not identical with the pattern on the bottom face 104, although such an arrangement is contemplated. In alternative embodiments, the grooves 110 may be arranged differently, including being differently spaced (e.g., into lines forming shapes, etc.), may be in different patterns on the top face 102 and bottom face 104, and in some embodiments may be omitted from either the top face 102 or the bottom face 104 altogether.

Like the first embodiment, in order to avoid presenting an overly rough surface which may potentially catch on a user's fingernail or otherwise cause a snag, the grooves 110 are preferably relatively between 0.02 and 0.05 inches in width, including 0.04 inches. Because the characteristics of any bar soap will be whether the first embodiment anchoring core 10 or the second embodiment anchoring core 100 is used, the grooves 110 are ideally between 0.01 and 0.02 inches deep, including 0.15 inches.

Referring to FIGS. 6 and 7, the second embodiment anchoring core 100 is shown embedded in the bar soap 112. In this view the anchoring core 100 is centered in the bar soap 112 to delay the emergence of the anchoring core 100 as long as possible and prevent the bar soap 112 from breaking up as it wears away from washing. The grooves 110 present an attractive design, such that as the anchoring core 100 emerges from under the bar soap 112, it can be left in view. In various alternative embodiments, it is anticipated that the anchoring grooves 110 or depressions 20 may be oriented, or in the form of predetermined indicia. In this manner, the anchoring core 100 can present a discoverable image, enabling for example a guessing game for children, and can also present branding indicia when the anchoring core 100 is used commercially. The anchoring core 100 can also be reused by pressing small softened pieces of several bars of soap (not shown) together on the anchoring core 100 and allowing them to dry.

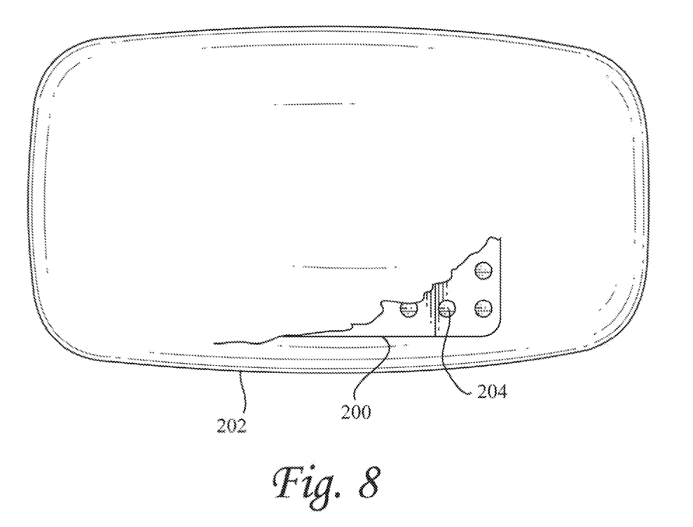

Referring to FIG. 8, a third embodiment bar soap anchoring core 200 is shown anchored in a square bar of soap 202. In this embodiment, the anchoring core 200 is also square and profiles the shape of the bar soap 202 as in the other embodiments. As the bar soap 202 is gradually worn away, becoming thinner and thinner, the anchoring core 200 acts to maintain its integrity. As shown, eventually the anchoring core 200 will be uncovered, but the depressions 204 will continue to hold the bar soap 202 until it completely disintegrates. At that time, the anchoring core 200 may be recycled or reused in the manner discussed.

Because the bar soap anchoring core is inexpensive to manufacture and use, its intended market will be soap manufacturers and distributors, where the anchoring cores will be inserted in the middle of bar soaps as they are manufactured. The method of insertion will depend on the nature of the soap molding process and technology at hand. The bar soap anchoring core will also be sold separately to retail stores. Consumers purchasing an anchoring core by itself may use it to adhere existing small leftover pieces of soap. For either purpose, it is anticipated that the anchoring core, as long as imbued with the adhering qualities discussed herein, may be made in any pattern, perimeter profile, shape or thickness according to preference.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for preserving structural integrity of used bar soap, the method comprising the steps of:
affixing initial pieces of the used bar soap into depressions found in top and bottom faces of a soap anchor;
using the bar soap affixed to the soap anchor for purposes of showering; and
reusing the soap anchor by affixing further pieces of used bar soap into the depressions found on the soap anchor where the initial pieces of bar soap had worn away.

2. A method of conveniently retaining solid soap pieces for complete use comprising:
providing a reusable substantially planar core having a top face and bottom face, and both the top and bottom faces having a plurality of anchoring structures extending inside the planar core;
pressing the solid soap pieces into the anchoring structures on the top and bottom faces of the substantially planar core;
using the solid soap pieces pressed into the planar core for washing purposes; and,
pressing additional solid soap pieces inside the anchoring structures of the planar core as needed.
